(19) United States
(12) Patent Application Publication
(10) Pub. No.: US 2025/0308041 A1
(43) Pub. Date: Oct. 2, 2025

(54) ELECTRONIC DEVICE, AND METHOD FOR GENERATING FACIAL POSITION INFORMATION IN INTERPOLATED FRAMES OF ELECTRONIC DEVICE

(71) Applicant: Samsung Electronics Co., Ltd., Suwon-si (KR)

(72) Inventors: Heejun Kim, Suwon-si (KR); Donghoon Kim, Suwon-si (KR); Geunhee Yang, Suwon-si (KR); Hojune Leu, Suwon-si (KR)

(21) Appl. No.: 19/097,079

(22) Filed: Apr. 1, 2025

(30) Foreign Application Priority Data
Apr. 2, 2024 (KR) 10-2024-0044785
Jul. 24, 2024 (KR) 10-2024-0098056

(51) Int. Cl. G06T 7/246; G06T 7/73; G06V 10/82; G06V 40/16

(52) U.S. Cl. CPC G06T 7/248; G06T 7/74; G06V 10/82; G06V 40/167; G06T 2207/10016; G06T 2207/30201

(57) ABSTRACT

A method of generating facial position information in interpolated frames of an electronic device including a face detection module, an optical flow circuit, and a face tracking module, the method including receiving, by the face tracking module, a frame and detection data from the face detection module and receiving an optical flow map from the optical flow circuit, determining, by the face tracking module, at least one patch of the optical flow map based on the frame and the detection data, calculating an estimated position of a face in the frame based on the patch, and generating facial position information in interpolated frames based on the calculated estimated position, wherein the detection data includes bounding box information of the face included in the frame, and landmark information of the face.

### CROSS-REFERENCE TO RELATED APPLICATION

This application is based on and claims priority under 35 U.S.C. § 119 to Korean Patent Application Nos. 10-2024-0044785, filed on Apr. 2, 2024, and 10-2024-0098056, filed on Jul. 24, 2024, in the Korean Intellectual Property Office, the disclosures of which are incorporated by reference herein in their entireties.

### BACKGROUND

Aspects of the inventive concept relate to an image processing method, and more particularly, to an electronic device and a method of generating facial position information in interpolated frames of the electronic device.

A system for image recognition or object detection which detects objects in an image may detect a single object or multiple objects from digital images or video frames. The object detection may refer to estimating the position and magnitude of an object in an image in the form of a bounding box and classifying a specific object within the given image.

Additionally, research on object tracking technology is actively underway. The object tracking technology is technology for detecting at least one object in an image or a video sequence acquired by an electronic device and simultaneously tracking the path of each of the at least one object. With regard to object tracking, there are demands for improving image quality, reducing processing time, and reducing power consumption.

### SUMMARY

Aspects of the inventive concept provide an electronic device with improved performance and a face tracking method performed by the electronic device.

According to an aspect of the inventive concept, there is provided a method of generating facial position information in interpolated frames of an electronic device including a face detection module, an optical flow circuit, and a face tracking module, the method including receiving, by the face tracking module, a frame and detection data from the face detection module and receiving an optical flow map from the optical flow circuit, determining, by the face tracking module, at least one patch of the optical flow map based on the frame and the detection data, calculating an estimated position of a face in the frame based on the patch, and generating facial position information in interpolated frames based on the calculated estimated position, wherein the detection data includes bounding box information of the face included in the frame, and landmark information of the face.

According to another aspect of the inventive concept, there is provided an electronic device including an optical flow circuit configured to detect optical flow of a received video and generate an optical flow map based on the detected optical flow, memory configured to store one or more instructions, and at least one processor configured to execute the one or more instructions stored in the memory, wherein the at least one processor, by executing the one or more instructions, is further configured to, using a neural network, detect a face in a frame and generate detection data including bounding box information of the face included in the frame and landmark information of the face, determine at least one patch of the optical flow map based on the frame and the detection data, calculate the estimated position of the face in the frame based on the patch, and generate facial position information in interpolated frames based on the calculated estimated position.

According to another aspect of the inventive concept, there is provided a method of generating facial position information in interpolated frames using an optical flow map, the method including detecting optical flow of a video and generating an optical flow map based on the detected optical flow, detecting a face in a frame included in the video using a neural network and generating detection data including bounding box information of the face included in the video and landmark information of the face, determining at least one patch of the optical flow map based on the frame and the detection data, calculating an estimated position of the face in the frame based on the patch, and generating facial position information in interpolated frames based on the calculated estimated position.

### BRIEF DESCRIPTION OF THE DRAWINGS

Embodiments will be more clearly understood from the following detailed description taken in conjunction with the accompanying drawings in which:

FIG. 1 is a block diagram of an electronic device according to an embodiment;

FIG. 2 is a detailed block diagram of the electronic device of FIG. 1;

FIG. 3 is a diagram illustrating detected optical flow of a video, according to an embodiment;

FIG. 4 is a diagram illustrating an operation in interpolated frames, according to an embodiment;

FIG. 5 is a flowchart of an operation method of an object tracking module in FIG. 1;

FIG. 6 is a flowchart of an operation method of an object tracking module in FIG. 1;

FIG. 7 is a detailed flowchart of operation S130 in FIG. 5;

FIGS. 8A to 8D are diagrams illustrating a patch according to an embodiment;

FIG. 9 is a flowchart of an operation method of an object tracking module in FIG. 1;

FIG. 10 is a flowchart of an operation method of an optical flow circuit in FIG. 1;

FIG. 11 is a flowchart of an operation method of a face detection module in FIG. 1;

FIG. 12 is a block diagram of an electronic device according to an embodiment;

FIGS. 13A and 13B are block diagrams of an electronic device according to an embodiment; and

FIG. 14 is a block diagram of an electronic device according to an embodiment.

### DETAILED DESCRIPTION OF THE EMBODIMENTS

Hereinafter, embodiments are described clearly and in detail so that a person skilled in the art may easily practice the inventive concept.

Hereinafter, various operations performed by at least one processor of an electronic device 100 may be directly implemented in hardware, software modules executed by the processor, or a combination thereof. When implemented in software, functions may be stored as one or more instructions or code in a tangible, non-transitory storage medium.

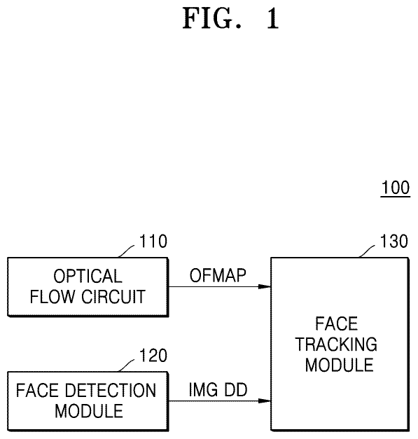

FIG. 1 is a block diagram of an electronic device according to an embodiment.

Referring to FIG. 1, the electronic device 100 may include an optical flow circuit 110, a face detection module 120 (or an object detection module), and a face tracking module 130 (or an object tracking module). The electronic device 100 may detect the optical flow of a video (or an image) and generate an optical flow map. Optical flow is the motion of objects between consecutive frames (e.g., images) of sequence, caused by the relative movement between the object and the electronic device 100 (e.g., a camera). As discussed in further detail below, information in an optical flow map represents information about the motion of objects, including their speed and direction. The electronic device 100 may detect or identify a face (or an object or a sub-object) in the image. The electronic device 100 may track the detected face. The electronic device 100 may generate facial position information in interpolated frames.

The electronic device 100 may include a computing system, a drone, an advanced driver-assistance system (ADAS), a robot, a medical device, a mobile device, a display device, a measurement device, or the Internet of Things (IoT). The electronic device 100 may include a smartphone, a personal computer (PC), a tablet PC, a smart TV, a mobile phone, a personal digital assistant (PDA), a laptop, a media player, a micro-server, a global positioning system (GPS) device, an e-reader, a digital broadcasting terminal, a navigation, a kiosk, an MP3 player, a digital camera, home appliances, and other mobile or non-mobile computing devices, but is not limited thereto. Additionally, the electronic device 100 may include a wearable device, such as a watch, glasses, a hair band, and a ring, that has communication functions and data processing functions.

The optical flow circuit 110 may detect the optical flow of the video. The optical flow circuit 110 may acquire (or obtain) the video (or input video). The optical flow may include information about the movement of an object included in the video. In an embodiment, when the video includes a plurality of frames, the optical flow may include information about a direction and a distance in which the object included in the video moves in the plurality of frames.

In an embodiment, the direction of the optical flow may correspond to the direction in which the object included in the video moves in the plurality of frames. In an embodiment, the magnitude of the optical flow may correspond to the magnitude of the distance that the object included in the video moves in the plurality of frames. In an embodiment, the optical flow may be detected based on two frames corresponding to two adjacent frames.

The optical flow circuit 110 may generate an optical flow map OFMAP based on the detected optical flow. The optical flow map OFMAP may include optical flow magnitude information and optical flow direction information. The optical flow circuit 110 may transmit the optical flow map OFMAP to the face tracking module 130.

The face detection module 120 may detect or identify a face in an image IMG. The face detection module 120 may receive the image IMG (or input image or input video). The face detection module 120 may detect the face included in the image IMG. The face detection module 120 may detect the face included in the image IMG using a neural network. The face detection module 120 may generate detection data DD (i.e., IMG DD). In an embodiment, the detection data DD may include region of interest (ROI) information of the face included in the image, bounding box information of the face included in the image, and landmark information (i.e., feature points) of the face. For example, in the context of a face, landmark information (i.e., feature points) may correspond to an identifiable point(s) on a face that can be used to locate and analyze facial features, such as eyes, cars, nose, mouth, chin, etc. The face detection module 120 may transmit the image IMG and the detection data DD to the face tracking module 130.

The face tracking module 130 may receive the optical flow map OFMAP from the optical flow circuit 110. The face tracking module 130 may receive the image IMG and the detection data DD from the face detection module 120. The face tracking module 130 may track the detected face. The face tracking module 130 may generate facial position information in interpolated frames. For example, the face tracking module 130 may generate face coordinates in the interpolated frames. The face tracking module 130 may track the face based on the optical flow map OFMAP, the image IMG, and the detection data DD to generate the facial position information in the interpolated frames.

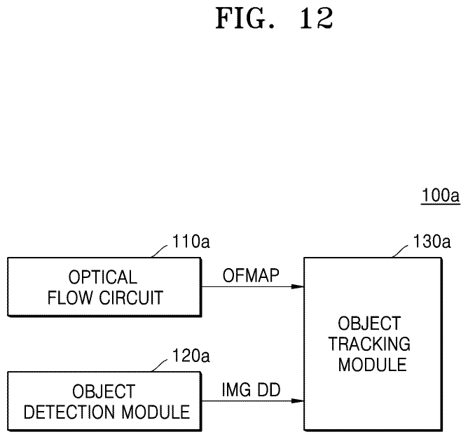

In an embodiment, the face tracking module 130 may generate the facial position information in the interpolated frames. Herein, the interpolated frame may refer to a frame in which a face detection operation or an object detection operation has not performed. For example, the interpolated frame may include a frame without face detection or objection detection. The interpolated frame may include a frame in which a face or object is not detected in an actually photographed frame. The interpolated frame may include a frame in which the face detection module 120 does not perform a face detection operation. The interpolated frame may also include a frame in which an object detection module 120 (see FIG. 12) does not perform an object detection operation. Herein, a noninterpolated frame (or simply “frame” or “image”), may refer to a frame in which a face detection operation or an object detection operation has been performed.

As described above, the electronic device 100 may generate the facial position information in the interpolated frames by using the detection data DD including the landmark information and the optical flow map OFMAP. Accordingly, the electronic device 100 may improve the quality of an image or a video. The electronic device 100 may reduce computing resources and power consumption. The electronic device 100 may reduce the time for image signal processing. The electronic device 100 may effectively generate face coordinates in the interpolated frames without using additional image processing algorithms. A face detection and face tracking method with improved performance may be provided. A face detection and face tracking method that has features that are resistant to changes in brightness may be provided. A method of generating facial position information (or face detection operation and face tracking operation) in interpolated frames is described in more detail with reference to the drawings below.

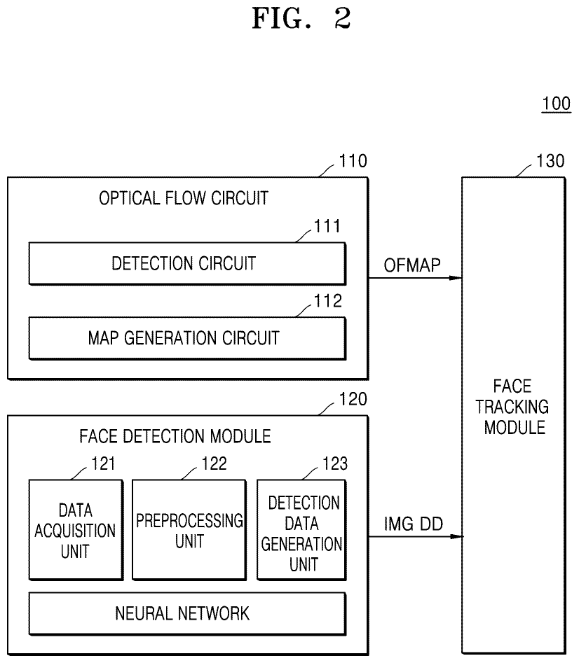

FIG. 2 is a detailed block diagram of the electronic device 100 of FIG. 1.

Referring to FIGS. 1 and 2, the electronic device 100 may include an optical flow circuit 110, a face detection module 120, and a face tracking module 130. The optical flow circuit 110, the face detection module 120, and the face tracking module 130 may be implemented with hardware components, software components, and/or a combination of hardware components and software components. The optical flow circuit 110 may include a detection circuit 111 and a map generation circuit 112. The face detection module 120 may include a data acquisition unit 121, a preprocessing unit 122, a detection data generation unit 123, and a neural network NN.

The detection circuit 111 may detect the optical flow based on the direction and the distance in which an object included in a plurality of frames of a video moves in the plurality of frames. In an embodiment, the optical flow may include a vector component having information about the direction and the distance in which the object moves in the plurality of frames.

The map generation circuit 112 may generate the optical flow map OFMAP. The optical flow map OFMAP may include optical flow direction information and optical flow magnitude information. Alternatively, the optical flow map OFMAP may include X-axis movement (or change in the X-axis direction) (dx) information and Y-axis movement (or change in the Y-axis direction) (dy) information. The map generation circuit 112 may provide the optical flow map OFMAP.

The face detection module 120 may identify a face or an object in an image. In an embodiment, the face detection module 120 may detect the face or the object in the image by using the neural network NN. The neural network NN may include a set of algorithms that identify and/or determine the object or the face in the image by extracting and using various attributes in the image using the results of statistical machine learning. Additionally, the neural network NN may be implemented as software or an engine for executing the above-described set of algorithms. The neural network NN implemented as software or an engine may be executed by a processor in the electronic device 100 or a processor in a server (not shown). The neural network NN may identify the object or the face in the image by abstracting various attributes in the image input to the neural network NN. In this case, the abstracting of attributes in the image may refer to detecting attributes from the image and determining key attributes among the detected attributes.

The neural network NN may include various types of neural network models, such as a convolution neural network (CNN), including GoogLeNet, AlexNet, and VGG Network, a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and a classification network, but is not limited thereto. Additionally, the neural network NN may include sub-neural networks, wherein the sub-neural networks may be implemented as heterogeneous neural networks.

The face detection module 120, according to an embodiment, may include the data acquisition unit 121, the preprocessing unit 122, and the detection data generation unit 123. However, this is only an example. The face detection module 120 may include some of the above-described components or may further include other components, in addition to the above-mentioned components.

The data acquisition unit 121 may acquire data necessary for identifying an object or a face. For example, the data acquisition unit 121 may acquire data by sensing the surroundings of the electronic device 100. In an embodiment, the data acquisition unit 121 may receive a video or an image from an image sensor of the electronic device 100. In an embodiment, the data acquisition unit 121 may acquire data from an external server, such as a social network server, a cloud server, or a content provision server.

The data acquisition unit 121 may acquire at least one of an image and a video. The video may be composed of multiple images (or multiple frames). As an example, the data acquisition unit 121 may receive the video through a camera of the electronic device 100 or an external camera (e.g., a CCTV camera or a black box) capable of communicating with the electronic device 100. The camera may include one or more image sensors (e.g., a front sensor or a rear sensor), a lens, an image signal processor (ISP), or a flash (e.g., an LED or xenon lamp).

Hereinafter, for convenience of explanation, terms, such as “image” and “frame”, are used interchangeably. These terms may have the same meaning or different meanings depending on the context of embodiments, wherein the meaning of each term may be understood according to the context of embodiments to be described.

The preprocessing unit 122 may preprocess the acquired data. The preprocessing unit 122 may process the data obtained for object identification into a preset format. For example, the preprocessing unit 122 may divide the input video into a plurality of images and detect the R attribute, G attribute, and B attribute from each of the plurality of images. Additionally, the preprocessing unit 122 may determine representative attribute values for attributes detected for each region of a predetermined magnitude from each of the plurality of images. The representative attribute values may include maximum attribute values, minimum attribute values, and average attribute values.

The detection data generation unit 123 may identify an object or a face in an image using the neural network NN. The detection data generation unit 123 may generate detection data DD that includes object/face identification information for the identified object. In an embodiment, the detection data DD may include a category in which the identified object is included, a name of the identified object, position information of the object, and the like. For example, the detection data DD may include ROI information, bounding box information for an object or a face, and landmark information. The detection data generation unit 123 may provide the detection data DD.

The face tracking module 130 may perform a face or object tracking operation. The face tracking module 130 may generate the facial position information in the interpolated frames. Accordingly, power consumption may be reduced. The face tracking module 130 may provide a video including interpolated frames in which a face or an object is tracked to an image signal processing module. For example, the image signal processing module may perform auto focus (AF), auto exposure (AE), and auto white balance (AWB) functions. The video including the interpolated frames may be used to perform the AE, AF, and AWB functions. The image signal processing module may perform various image processing operations, such as defective pixel correction, offset correction, lens distortion correction, color gain correction, and green imbalance correction, based on the video including the interpolated frames.

As existing face tracking modules are sensitive to changes in illumination, there are demands for improving the image quality, reducing the processing time, and reducing the power consumption. During the initialization operation of the camera included in the electronic device 100, the brightness/color may change rapidly. The existing face tracking modules have limitations in that face tracking performance deteriorates when the brightness/color changes rapidly.

The face tracking module 130, according to an embodiment, may generate the facial position information in the interpolated frames based on the detection data DD including landmark information and the optical flow map OFMAP. The face tracking module 130 may recycle the optical flow map OFMAP, thereby eliminating an image resizing operation. Accordingly, the face tracking module 130 may have a reduced computational amount, compared to the existing face tracking modules. The face tracking module 130 may enable more accurate coordinate tracking. The face or object tracking method, according to an embodiment, may improve face or object tracking performance in an environment where the brightness/color changes rapidly. Accordingly, the electronic device 100 may improve the image and video quality, reduce the processing time, and reduce the power consumption.

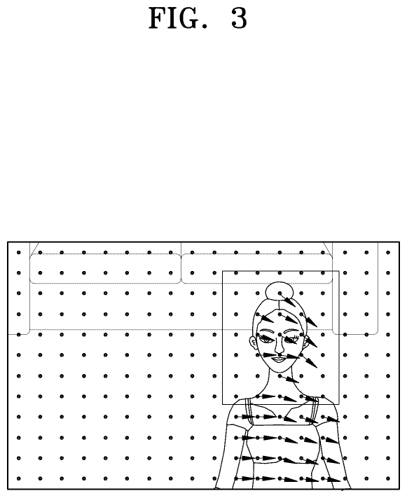

FIG. 3 is a diagram illustrating detected optical flow of a video, according to an embodiment.

In an embodiment, the optical flow circuit 110 may acquire an input video. The optical flow circuit 110 may receive the input video. In an embodiment, the input video may include a video obtained by photographing. In an embodiment, the input video may include an object and a background. Herein, the object may refer to at least one of an article, a person, or an animal that is set by a user and is of interest to the user, and the background may refer to anything other than the object in the image frame. The object included in the input video may include a face. In an embodiment, when the electronic device 100 includes a photographing device (or image sensor), such as a camera, the electronic device 100 may obtain the input video by directly photographing the object. However, aspects of the inventive concept are not limited thereto. The electronic device 100 may acquire the input video through an input/output interface (not shown).

In an embodiment, an input video shown in FIG. 3 is shown as a video obtained by photographing a background that does not move over time and a moving object that moves over time. However, aspects of the inventive concept are not limited thereto. The input video may include two or more moving objects that move over time, wherein the movement direction and movement speed of each of the two or more moving objects may be different. In addition, in an embodiment, the input video may include a video obtained by photographing only the background that does not move over time. Hereinafter, for convenience of explanation, the input video is described as including one moving object that moves over time and a background that does not move over time.

The optical flow circuit 110 may detect the optical flow of the input video. In an embodiment, the input video may include a plurality of frame images corresponding to a plurality of frames, respectively. The optical flow circuit 110 may identify the positions of the moving object and the background, each included in the input video, in a plurality of frames and detect the optical flow including information about the direction and the distance in which the moving object and the background move.

In an embodiment, the optical flow circuit 110 may identify the positions of the moving object and the background, each included in the input video, in two adjacent frames to detect the optical flow that includes information about the direction and distance in which the moving object and the background move. In an embodiment, the optical flow may include a vector including a magnitude component and a direction component. Hereinafter, for convenience of explanation, the optical flow is described as having a magnitude and a direction.

The input video (or image) may include a plurality of points (e.g., pixels) arranged in rows and columns. The optical flow circuit 110 may detect the optical flow of the plurality of points. Some of the plurality of points may be included in the background. Some of the plurality of points may be included in the moving object.

In an embodiment, the magnitude and direction of the optical flow of the moving object included in the input video may be different from the magnitude and direction of the optical flow of the background included in the input video. In an embodiment, the magnitude of the optical flow of the moving object may be greater than the magnitude of the optical flow of the background. In an embodiment, as the background does not move over time, the optical flow of the background may not contain the direction component. In an embodiment, as the moving object moves over time, the optical flow of the moving object may include the direction component in a direction in which the moving object moves.

The optical flow circuit 110 may generate the optical flow map OFMAP. The optical flow map OFMAP may include optical flow data of the plurality of points. The optical flow map OFMAP may include a plurality of pieces of optical flow data. The optical flow map OFMAP generated may be a dense optical flow map or a sparse optical flow map. A dense optical flow map may include information (e.g., flow vectors) of all the points included in the video frame or image. For example, when the optical flow circuit 110 generates a dense optical flow map, the number of pieces of optical flow data included in the optical flow map OFMAP may be equal to the number of points included in the input video (e.g., frame or image). A sparse optical flow map may include information of some of the points (e.g., points depicting the edges or corners of an object) included in the video frame or image. For example, when the optical flow circuit 110 generates a sparse optical flow map, the number of pieces of optical flow data included in the optical flow map OFMAP may be less than the number of points included in the input video.

The optical flow data may include magnitude information of the optical flow of the corresponding points and direction information of the optical flow of the corresponding points. Alternatively, the optical flow data may include X-axis movement (or change in the X-axis direction) (dx) information of the corresponding points, and Y-axis movement (or change in the Y-axis direction) (dy) information of the corresponding points.

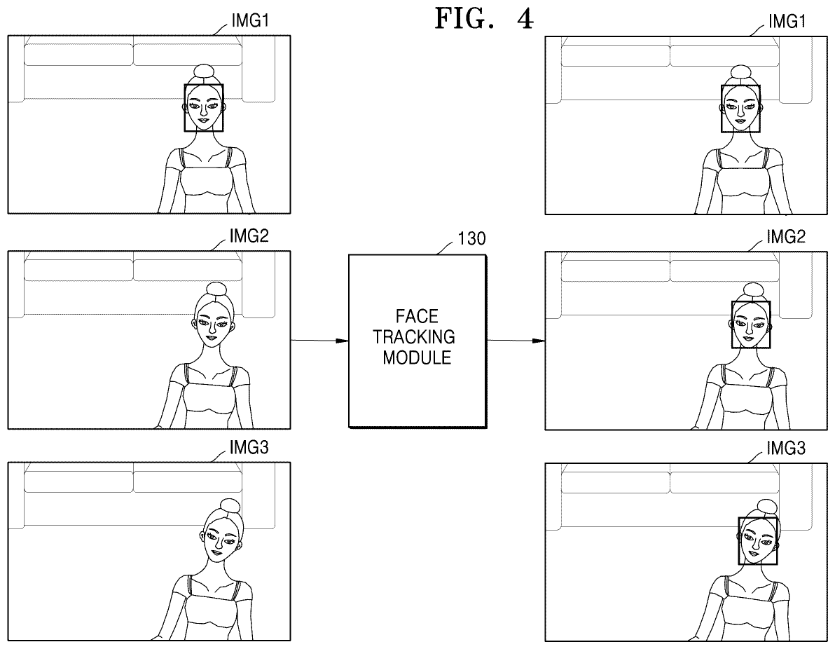

FIG. 4 is a diagram illustrating an operation in interpolated frames, according to an embodiment.

Referring to FIGS. 1 and 4, the face tracking module 130 may generate facial position information in interpolated frames. The face tracking module 130 may receive the image IMG, the detection data DD, and the optical flow map OFMAP. The face tracking module 130 may generate the facial position information in the interpolated frames based on the image IMG, the detection data DD, and the optical flow map OFMAP.

For example, the face tracking module 130 may receive a first image IMG1, a second image IMG2, a third image IMG3, and a first optical flow map and a second optical flow map. The face tracking module 130 may acquire the first image IMG1 to the third image IMG3 included in the input video. The face detection module 120 may detect a face or an object in the first image IMG1. The face detection module 120 may not detect a face or an object in the second image IMG2. The face detection module 120 may not detect a face or an object in the third image IMG3. Accordingly, IMG2 and IMG3 may each represent an interpolated frame.

The face tracking module 130 may generate the facial position information in the interpolated frames. In other words, the face tracking module 130 may track a face or an object in the second image IMG2. The face tracking module 130 may track a face or an object in the third image IMG3. The second image IMG2 and the third image IMG3 may include interpolated frames. The first image IMG1 may include a frame at a first time, the second image IMG2 may include a frame at a second time, and the third image IMG3 may include a frame at a third time. Temporally, the second image IMG2 may be located between the first image IMG1 and the third image IMG3. The first image IMG1 may include a first frame, the second image IMG2 may include a second frame consecutive to the first frame, and the third image IMG3 may include a third frame consecutive to the second frame.

The face tracking module 130 may generate the facial position information in the second image IMG2 based on the first image IMG1, the second image IMG2, and the first optical flow map. The face tracking module 130 may generate the facial position information in the third image IMG3 based on the first image IMG1, the second image IMG2, the third image IMG3, and the second optical flow map.

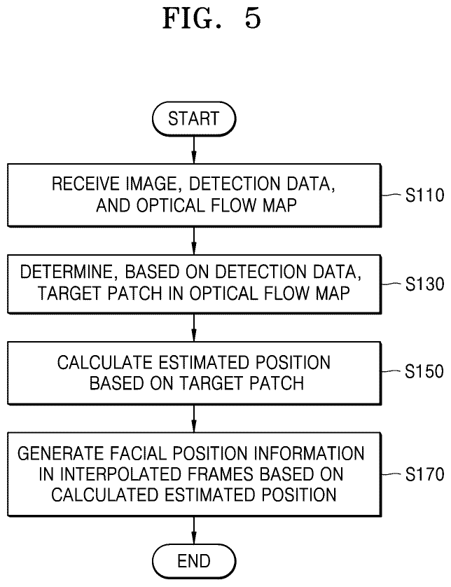

FIG. 5 is a flowchart of an operation method of an object tracking module in FIG. 1.

Referring to FIGS. 1 and 5, the face tracking module 130 may receive the image IMG, the detection data DD, and the optical flow map OFMAP. The face tracking module 130 may track an object based on the image IMG, the detection data DD, and the optical flow map OFMAP. The face tracking module 130 may generate the facial position information in the interpolated frames based on the image IMG, the detection data DD, and the optical flow map OFMAP.

In operation S110, the face tracking module 130 may receive the image IMG, the detection data DD, and the optical flow map OFMAP. In an embodiment, the face tracking module 130 may receive the image IMG and the detection data DD from the face detection module 120. The face tracking module 130 may receive the optical flow map OFMAP from the optical flow circuit 110.

The detection data DD may include position information indicating the position of the object, identification features for identifying the object, and the like. In an embodiment, the detection data DD may include ROI information, bounding box information, and landmark information. The ROI may refer to a region including an object of interest. The ROI information may include position information of ROI. The bounding box may represent the position and magnitude of an object as a rectangle. The bounding box information may include position information of the bounding box within an image. For example, the bounding box information may include position coordinate data of each vertex of the bounding box. For example, the bounding box may indicate the entire face of an object. In this case, the bounding box information may include the magnitude of the bounding box indicating the entire face in the image, position information about the border of the bounding box, and position information about the center of the bounding box. In an embodiment, the detection data DD may further include object identification information indicating the type of object.

In an embodiment, the detection data DD may further include position information about the center of an object or a face in the image. For example, the detection data DD may further include center position information, which is position information about the center region of the bounding box (or ROI).

In an embodiment, the landmark information may include landmark coordinates and landmark position data. The landmark information may include a landmark identifier and a landmark set. For example, the landmark information may include a first landmark identifier, a first landmark set corresponding to the first landmark identifier, a second landmark identifier, and a second landmark set corresponding to the second landmark identifier. The landmark set may include position information of at least one point indicating a specific landmark in the image.

For example, the first landmark identifier indicates the cars of a face and the first landmark set may include position information of a plurality of points indicating the cars of the face in the image. The second landmark identifier indicates the eyes of the face and the second landmark set may include position information of a plurality of points indicating the eyes of the face in the image.

In operation S130, the face tracking module 130 may determine, based on the detection data DD, a target patch (e.g., a region of the optical flow map OFMAP corresponding to the detection data DD, which may include ROI information, bounding box information, and landmark information) in the optical flow map OFMAP. The target patch may include at least one patch. The patch may include flow optical data of each of the points included in a target region. The patch may indicate a portion of the optical flow map OFMAP. The patch may indicate a portion of the optical flow map OFMAP used to calculate the estimated position. The patch may include optical flow data used to determine the estimated position of an object or a face in the image. The estimated position may refer to a position in the image where an object or a face is estimated to be present in the interpolated frames.

The face tracking module 130 may determine the target patch to include different regions (e.g., areas or portions) within the bounding box (or the ROI). The different regions within the bounding box (or the ROI) may be referred to herein as, for example, a first patch, a second patch, a third patch, etc. In an embodiment, the face tracking module 130 may determine a first patch, corresponding to the center region in the bounding box (or the ROI), as the target patch. The first patch may include optical flow data of points included in the center region in the bounding box. The first patch may correspond to the center region in the bounding box. The first patch may include optical flows included in the center region of the bounding box in the image.

In operation S150, the face tracking module 130 may calculate the estimated position of a face or an object based on the target patch. The estimated position may refer to a position in the image where an object or a face is estimated to be present in the interpolated frames. In an embodiment, the face tracking module 130 may calculate a distance and a direction in which a face or an object moves based on the target patch. The face tracking module 130 may determine the estimated position based on the calculated direction and magnitude of movement. The estimated position may be determined based on the position of the object in the image and the calculated direction and magnitude of movement.

The face tracking module 130 may calculate the magnitude of the distance that the face or object moves in a first direction (e.g., an X-axis). The face tracking module 130 may calculate the magnitude of the distance that the face or object moves in a second direction (e.g., Y-axis) perpendicular to the first direction. The face tracking module 130 may calculate the estimated position based on the magnitude of the movement distance in the first direction and the magnitude of the movement distance in the second direction. In an embodiment, the face tracking module 130 may calculate the estimated position through an average of the optical flow data included in the target patch.

In operation S170, the face tracking module 130 may generate the facial position information in the interpolated frames based on the calculated movement distance. The face tracking module 130 may generate the facial position information in the interpolated frames based on the image IMG and the estimated position. The face tracking module 130 may move the face box (e.g., bounding box (or ROI)) to the estimated position in the image. The face tracking module 130 may track the object to generate face coordinates of the interpolated frames.

As described above, the face tracking module 130 may track a face or an object based on the detection data DD including the landmark information and the optical flow map OFMAP to generate position information of the face or the object in the interpolated frames. Accordingly, instead of performing a face detection operation on all frames, the face detection operation may be performed on some frames to optimize power consumption. The face tracking module 130 may effectively generate the position information in the interpolated frames without using additional image processing algorithms to generate the facial position information.

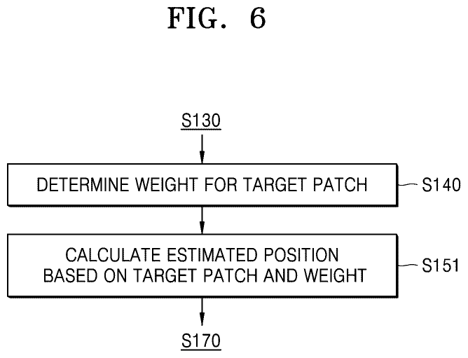

FIG. 6 is a flowchart of an operation method of an object tracking module in FIG. 1.

Referring to FIGS. 1, 5, and 6, the face tracking module 130 may determine weights for patches in the method of generating facial position information in interpolated frames. The face tracking module 130 may perform operation S140. Operation S150 in FIG. 5 may include operation S151.

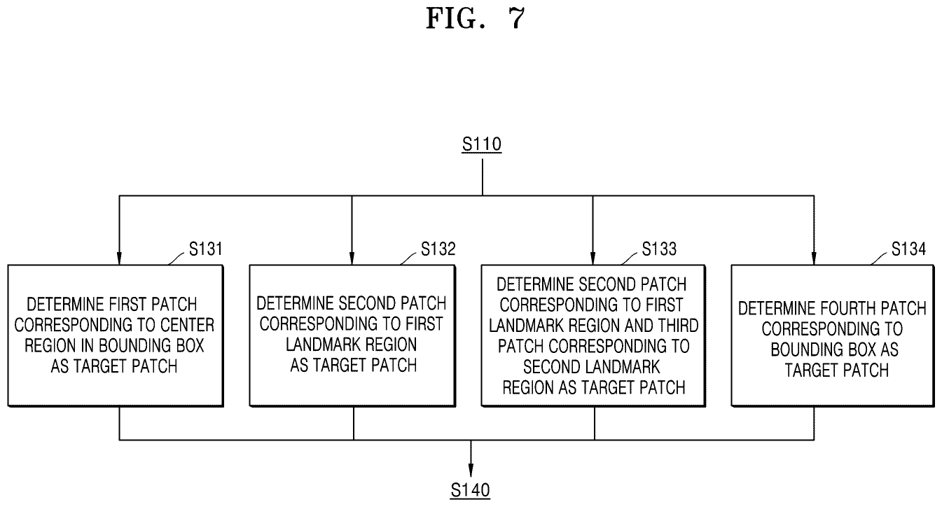

In operation S130, the face tracking module 130 may determine the target patch in the optical flow map OFMAP. For example, as discussed in further detail with respect to FIG. 7, the face tracking module 130 may determine at least one patch as the target patch. As discussed above, the face tracking module 130 may determine a first patch, corresponding to the center region in the bounding box (or the ROI), as the target patch. As a further example, the face tracking module 130 may determine a second patch corresponding to the first landmark set indicating the eyes as the target patch. Also, the face tracking module 130 may determine a third patch corresponding to the second landmark set indicating the mouth as the target patch. Also, the target patch may include a combination of two or more of the first patch, the second patch, and the third patch. For example, the target patch may include the first patch and the second patch.

In operation S140, the face tracking module 130 may determine weights for patches included in the target patch. For example, the face tracking module 130 may determine weights corresponding to the patches. The face tracking module 130 may assign a first weight to the second patch and a second weight to the third patch. The first weight may be different from the second weight. In an embodiment, the weights may be determined based on at least one of a Gaussian weight, a Constant weight, an L1 norm, and an L2 norm. In an embodiment, the weights may be determined according to a priority of predetermined landmarks. In an embodiment, the face tracking module 130 may determine weights for the patches, based on the center position information and the distance from the center coordinate of the bounding box.

In operation S151, the face tracking module 130 may calculate the estimated position based on the target patch and the weights. The face tracking module 130 may calculate a direction and a distance in which the object or the face moves, based on the at least one patch and the weights. The face tracking module 130 may determine the estimated position based on the calculated direction and magnitude of distance in which the object moves. The face tracking module 130 may apply a weight corresponding to the patch to calculate the estimated position. For example, the face tracking module 130 may calculate the estimated position by multiplying the patch by the corresponding weight.

As described above, the face tracking module 130 may determine weights for patches included in the target patch. Accordingly, the face tracking method with improved performance is provided.

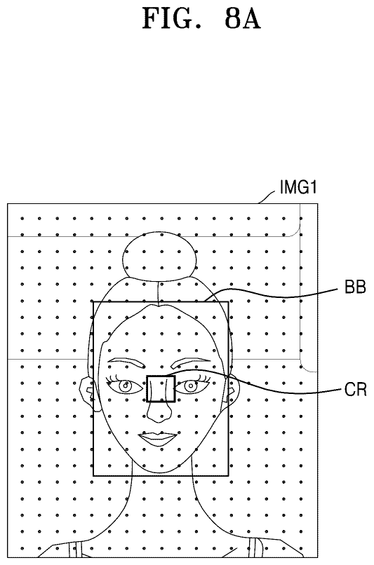

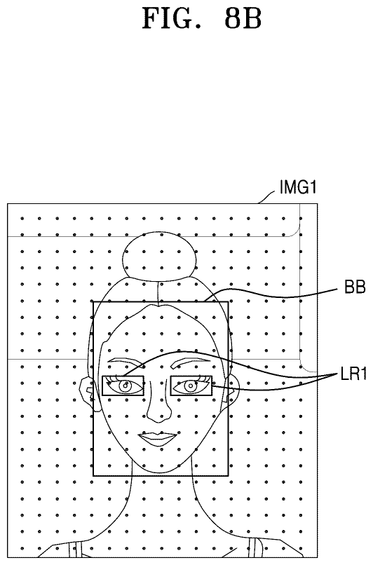

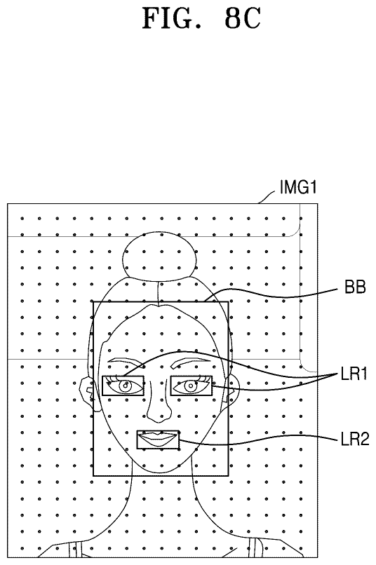

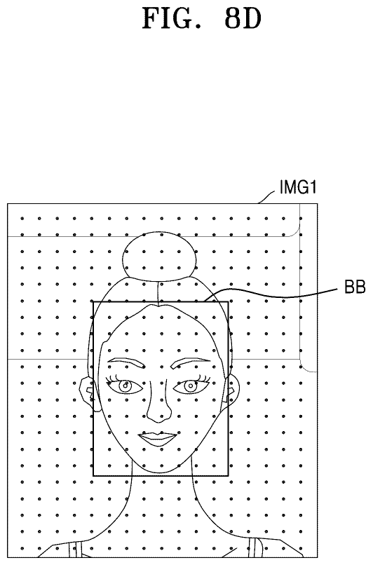

FIG. 7 is a detailed flowchart of operation S130 in FIG. 5. FIGS. 8A to 8D are diagrams illustrating a patch according to an embodiment.

Referring to FIGS. 1, 5, and 7, the face tracking module 130 may determine, based on the detection data DD, the target patch. In one embodiment, the face tracking module 130 may determine at least one of the first to fourth patches as a target patch. For example, the target patch may be an optimal patch. The face tracking module 130 may determine an optimal patch in the optical flow map OFMAP. The target patch may include at least one patch. The face tracking module 130 may determine at least one patch of the optical flow map OFMAP based on the detection data DD. Operation S130 in FIG. 5 may include operations S131 to S134.

The face tracking module 130 may receive, in operation S110, the image IMG, the detection data DD, and the optical flow map OFMAP. The face tracking module 130 may perform at least one of operations S131 to S134. In operation S131, the face tracking module 130 may determine the first patch of the optical flow corresponding to the center region in the bounding box as the target patch.

FIG. 8A is a diagram illustrating a center region CR of a bounding box BB in an image IMG1. The bounding box BB may indicate a face region of the object. The center region CR may refer to a center portion of the bounding box BB. The detection data DD may include center position information including position information on the center region CR. The center position information may include coordinates for the center of the bounding box BB.

The face tracking module 130 may determine, based on the center position information included in the detection data DD, the first patch of the optical flow map OFMAP corresponding to the center region CR as the target patch. For example, the first patch may include optical flow data of points included in the center region CR.

In operation S132, the face tracking module 130 may determine the second patch, corresponding to a first landmark region LR1, as the target patch. For example, referring to FIG. 8B, FIG. 8B is a diagram illustrating the first landmark region LR1 of the image IMG1. The bounding box BB may indicate a face region of the object. The first landmark region LR1 may indicate the eyes of the face. The detection data DD may include a first landmark set corresponding to the first landmark region LR1. The first landmark set may include position information of a plurality of points indicating the eyes of the face in the image.

The face tracking module 130 may determine, based on the first landmark set included in the detection data DD, the second patch of the optical flow map OFMAP corresponding to the first landmark region LR1 as the target patch. For example, the second patch may include optical flow data of points included in the first landmark region LR1.

In operation S133, the face tracking module 130 may determine the second patch corresponding to the first landmark region LR1 and the third patch corresponding to the second landmark region LR2 as the target patch. For example, referring to FIG. 8C, FIG. 8C is a diagram illustrating the first landmark region LR1 and the second landmark region LR2 of the image IMG1. The bounding box BB may indicate a face region of the object. The first landmark region LR1 may indicate the eyes of the object. The second landmark region LR2 may indicate the mouth of the object. The detection data DD may include a first landmark set corresponding to the first landmark region LR1. The first landmark set may include position information of a plurality of points indicating the eyes of the face in the image. The detection data DD may include a second landmark set corresponding to the second landmark region LR2. The second landmark set may include position information of a plurality of points indicating the mouth of the face in the image.

The face tracking module 130 may determine, based on the first landmark set included in the detection data DD, the second patch of the optical flow map OFMAP corresponding to the first landmark region LR1 as the target patch, and determine the third patch of the optical flow map OFMAP corresponding to the second landmark region LR2 included in the detection data DD as the target patch. For example, the face tracking module 130 may determine the combination of both the second patch and the third patch as the target patch. The second patch may include optical flow data of the points included in the first landmark region LR1. The third patch may include optical flow data of points included in the second landmark region LR2.

In operation S134, the face tracking module 130 may determine a fourth patch corresponding to the bounding box BB as the target patch. For example, referring to FIG. 8D, FIG. 8D is a diagram illustrating the bounding box BB of the image IMG1. The bounding box BB may indicate a face region of the object. The detection data DD may include position information of the bounding box BB.

The face tracking module 130 may determine, based on the position information of the bounding box BB included in the detection data DD, the fourth patch of the optical flow map OFMAP corresponding to the bounding box BB as the target patch. The fourth patch may include optical flow data of points included in the bounding box BB.

The above-described embodiments are described with reference to the bounding box, but the scope of the inventive concept is not limited thereto. For example, the center region CR, the first landmark region LR1, the second landmark region LR2, and the like may be described based on an ROI. The center region CR may refer to the center region of the ROI, the first landmark region LR1 may be present in the ROI, and the second landmark region LR2 may be present in the ROI. The fourth patch may correspond to the ROI.

As described above, the face tracking module 130 may not use all optical flow data of the optical flow map OFMAP, but instead may use only a portion of the optical flow data to calculate the estimated position. The average movement value of the landmark region may be the same as or similar to the movement value of the face. The face tracking module 130 may select a patch based on the detection data DD. Accordingly, the face tracking module 130 may calculate the estimated position based on some of the optical flow data of the optical flow map OFMAP. As only a portion (e.g., some) of the optical flow data of the optical flow map OFMAP is used, the processing time of the face tracking operation may be reduced. Accordingly, a face detection and face tracking method with improved performance is provided.

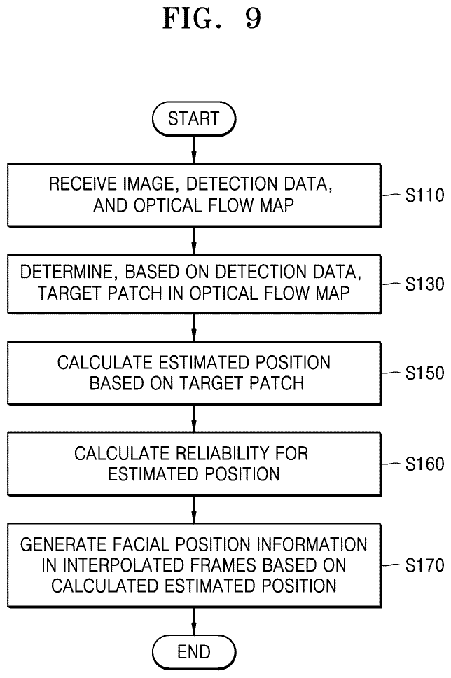

FIG. 9 is a flowchart of an operation method of an object tracking module in FIG. 1.

Referring to FIGS. 1, 5, and 9, the face tracking module 130 may perform the face tracking operation. The face tracking module 130 may generate facial position information in the interpolated frames. The face tracking module 130 may perform operations S110 to S170. Since operations S110, S130, S150, and S170 of FIG. 9 are similar to operations S110, S130, S150, and S170 of FIG. 5, a detailed description thereof may be omitted.

In operation S110, the face tracking module 130 may receive the image IMG, the detection data DD, and the optical flow map OFMAP. In operation S130, the face tracking module 130 may determine, based on the detection data DD, the target patch in the optical flow map OFMAP. In operation S150, the face tracking module 130 may calculate the estimated position of the face or the object based on the target patch.

In operation S160, the face tracking module 130 may calculate reliability of the estimated position. The face tracking module 130 may verify whether the direction and magnitude of movement calculated in operation S150 are accurate. Alternatively, the face tracking module 130 may verify that the magnitude of the movement distance in the first direction and the magnitude of the movement distance in the second direction calculated in operation S150 are not accurate. The reliability may refer to a degree to which the position of the object or face tracked by the face tracking module 130 matches the position of the object or face in a ground truth (GT) frame. In an embodiment, the reliability may be calculated based on any of the following methods: histogram comparison, specific mask, and color comparison of edge regions.

In an embodiment, the face tracking module 130 may perform operation S110 again after operation S160 when the reliability is less than a predetermined threshold. The face tracking module 130 may change the target patch to calculate the estimated position. For example, the face tracking module 130 may determine the fourth patch as the target patch to improve the reliability. That is, the target patch may be changed from the first patch to the fourth patch. The target patch is determined as a different target patch that was not used in the previous operations S110 to S160. The face tracking module 130 may recalculate, based on the fourth patch, the estimated position. When the reliability is greater than or equal to the predetermined threshold, the face tracking module 130 may perform operation S170. In operation S170, the face tracking module 130 may generate the facial position information in the interpolated frames based on the calculated movement distance.

In an embodiment, operations S110 to $170 may be performed to generate facial position information in one interpolated frame. To generate facial position information in each of the plurality of interpolated frames, operations S110 to S170 may be repeatedly performed. The number of iterations of the face tracking operation may be determined based on the frame ratio and the scenario.

As described above, the face tracking module 130 may calculate the reliability and re-calculate the estimated position when the reliability is low. The face tracking module 130 may change the target patch and re-calculate the estimated position to increase the reliability. Accordingly, the face tracking method with improved performance is provided.

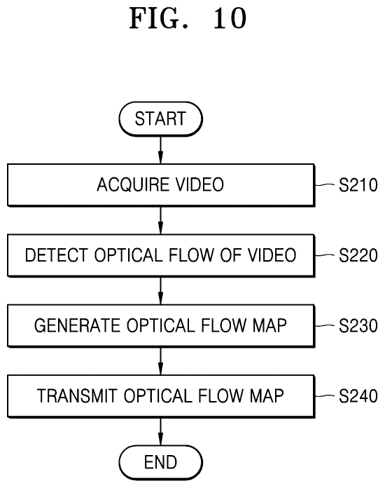

FIG. 10 is a flowchart of an operation method of an optical flow circuit in FIG. 1.

Referring to FIGS. 1 and 10, the optical flow circuit 110 may detect the optical flow of the video by using a neural network or deep learning and may generate the optical flow map. In operation S210, the optical flow circuit 110 may obtain an input video. The optical flow circuit 110 may receive an image or a video from an image sensor (not shown) or an ISP (not shown). Alternatively, the optical flow circuit 110 may obtain an image or a video from an external source (e.g., a server).

In operation S220, the optical flow circuit 110 may detect the optical flow of the input video. In operation S230, the optical flow circuit 110 may generate the optical flow map. The optical flow map may include optical flow data of a plurality of points included in the input video. The optical flow data may include information on the amount of movement of the points in the first direction and information on the amount of movement of the points in the second direction perpendicular to the first direction. Alternatively, the optical flow data may include direction information of movement and magnitude information of movement distance of the points.

In operation S240, the optical flow circuit 110 may transmit the optical flow map. The optical flow circuit 110 may provide the optical flow map to multiple modules. The optical flow circuit 110 may provide the optical flow map to the face tracking module 130.

As described above, the optical flow circuit 110 may detect the optical flow of the video using deep learning or the neural network and provide the optical flow map. The electronic device 100 may generate the facial position information in the interpolated frames by using the optical flow map. Accordingly, the face tracking method according to an embodiment may have features that are resistant to brightness/color changes.

The optical flow circuit 110 may generate the optical flow map for motion detection. Various image signal processing modules, including the face tracking module 130, may process image signals using the optical flow map. In an embodiment, the optical flow map may be used for noise reduction. For example, a noise reduction module (not shown) may remove noise for an image or a video, based on the optical flow map. The noise reduction module may remove fixed-pattern noise or temporary random noise according to a color filter array (CFA) of the image sensor based on the optical flow map. The various image signal processing modules may reuse the optical flow map generated by the optical flow circuit 110. In addition to face or object tracking, the optical flow map may be used for image signal processing for motion detection or image quality improvement.

The electronic device 100 according to an embodiment may use the optical flow map for motion detection or noise removal, as well as face detection and face tracking operations. The electronic device 100 may reuse the optical flow map used for motion detection, to generate the facial position information in the interpolated frames. The electronic device 100 may use the optical flow map for both moving and stationary objects to detect and track a face (or an object). Accordingly, performance of image signal processing may be improved. The electronic device 100 may improve the image quality of an image or a video.

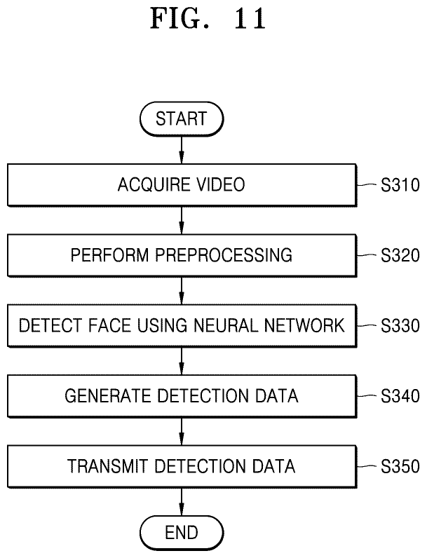

FIG. 11 is a flowchart of an operation method of a face detection module in FIG. 1.

Referring to FIGS. 1 and 11, the face detection module 120 may detect a face or an object in an image using a neural network. The face detection module 120 may generate detection data DD. The face detection module 120 may provide the detection data DD.

In operation S310, the face detection module 120 may obtain an input video. In an embodiment, the face detection module 120 may receive an input video or an input image from an image sensor or an ISP. In an embodiment, the face detection module 120 may receive an input video or an input image from an external device or an external server.

In operation S320, the face detection module 120 may perform preprocessing on the input video.

In operation S330, the face detection module 120 may detect a face or an object by using the neural network. The face detection module 120 may identify a face or an object in the image or the video by using deep learning. Alternatively, the face detection module 120 may identify a plurality of faces or objects in the image or the video.

In an embodiment, the face detection module 120 may detect image attributes that are already set in the image and determine a position of each of the objects or faces in the image, a category corresponding to each of the objects or faces, and/or a landmark of each of the objects or faces, based on the detected image attributes. The image attributes may represent unique features of the image that can be applied as input parameters of the neural network for identifying the object. For example, the image attributes may include, but are not limited to, colors, edges, polygons, saturation, brightness, color temperature, blur, sharpness, and contrast of the image.

In operation S340, the face detection module 120 may generate the detection data DD. The face detection module 120 may generate the detection data DD for each of the identified faces. For example, the face detection module 120 may generate detection data DD for a first face and generate detection data DD for a second face when identifying the first face and the second face. The detection data DD may include a position (e.g., coordinates of pixels corresponding to an object) of each of the faces or objects included in the image, a category of each of the objects, and/or a position (e.g., coordinates of pixels corresponding to a landmark) of each of landmarks of the face.

In operation S350, the face detection module 120 may transmit the detection data DD. The face detection module 120 may provide the detection data DD to the face tracking module 130.

FIG. 12 is a block diagram of an electronic device according to an embodiment.

Referring to FIG. 12, an electronic device 100a may include an optical flow circuit 110a, an object detection module 120a, and an object tracking module 130a. Although the above-described embodiments are described with reference to face detection and face tracking operations of the electronic device 100a, the scope of the inventive concept is not limited thereto. For example, the electronic device 100a may perform an object detection operation and perform an object tracking operation. The electronic device 100a may generate the object position information in the interpolated frames through the object detection operation and the object tracking operation.

The optical flow circuit 110a may be the same as or similar to the optical flow circuit 110 of FIG. 1, the object detection module 120a may be the same or similar to the face detection module 120 of FIG. 1, and the object tracking module 130a may be the same as or similar to the face tracking module 130 of FIG. 1.

The object detection module 120a may identify, using the neural network, an object in the image. The object detection module 120a may identify, using the neural network, a sub-object of the object in the image. For example, the object may refer to at least one of a building, an article, a person, an animal or plant of interest to a user. The sub-object may refer to a portion of an object. For example, when the object is a person, the sub-object may include a face. In an embodiment, the detection data DD may include bounding box information of an object included in the image, landmark information of the object, bounding box information of a sub-object included in the image, and landmark information of the sub-object.

The object tracking module 130a may receive the image IMG and the detection data DD. The object tracking module 130a may receive at least one optical flow map OFMAP. The object tracking module 130a may receive a plurality of optical flow maps OFMAP to generate the object position information in the plurality of interpolated frames.

The object tracking module 130a may track the detected object. The object tracking module 130a may determine, based on the detection data DD, at least one patch of the optical flow map OFMAP. The object tracking module 130a may calculate, based on the patch, the estimated position of the object or the sub-object in the image. The object tracking module 130a may calculate the movement distance and the movement direction of the object or the sub-object in the image based on the patch. The object tracking module 130a may generate the object position information in the interpolated frames based on the estimated position. Accordingly, the object detection and object tracking method with improved performance is provided.

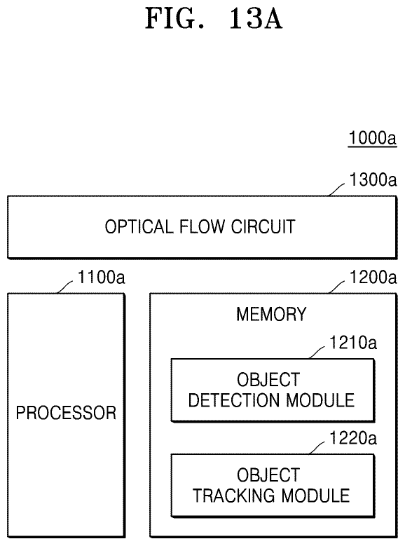

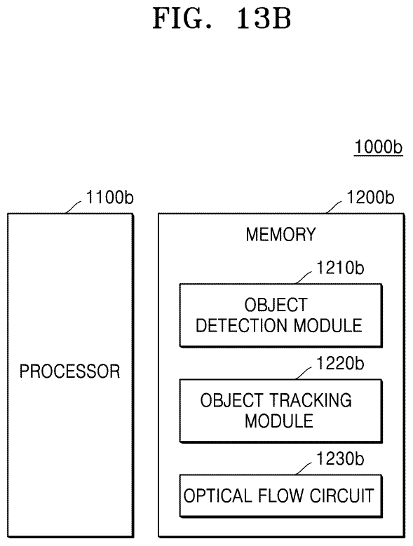

FIGS. 13A and 13B are block diagrams of an electronic device according to an embodiment.

Referring to FIGS. 1 and 13A, an electronic device 1000a may include a processor 1100a, memory 1200a, and an optical flow circuit 1300a. The memory 1200a may include an object detection module 1210a and an object tracking module 1220a.

The memory 1200a may store various data, programs, or applications for driving and controlling the electronic device 1000a. The program stored in the memory 1200a may include one or more instructions. The program (one or more instructions) or the application stored in the memory 1200a may be executed by the processor 1100a.

In an embodiment, the memory 1200a may include one or more instructions for configuring a neural network. In addition, the memory 1200a may include one or more instructions for controlling the neural network. The neural network may be configured with a plurality of layers including one or more instructions to identify, detect, and/or determine objects (or faces, landmarks, etc.) in the image from the input image.

The processor 1100a may execute an operating system (OS) and various applications stored in the memory 1200a. The processor 1100a may include one or more processors including a single core, a dual core, a triple core, a quad core, and multiple cores. In addition, for example, the processor 1100a may be implemented as a main processor (not shown) and a sub-processor (not shown) operating in a sleep mode.

The processor 1100a, according to an embodiment, may obtain an image. For example, the processor 1100a may read an image stored in the memory 1200a by executing a photo album application or the like. Alternatively, the processor 1100a may receive an image from an external source (e.g., an SNS server, a cloud server, and a content providing server) through a communication unit (not shown). Alternatively, the processor 1100a may obtain an image from an image sensor (not shown). The processor 1100a may obtain a preview image and a captured image through a camera unit (not shown).

In an embodiment, the processor 1100a may identify objects in an image using instructions that configure the neural network stored in the memory 1200a. The processor 1100a may detect a face in an image and detect a landmark of the face by using the instructions that configure the neural network stored in the memory 1200a. The processor 1100a may generate detection data.

As a result, the processor 1100a may track the object based on the optical flow map and the detection data to generate facial position information in the interpolated frames. The processor 1100a may perform the object detection and object tracking operations described with reference to FIGS. 1 to 12. The processor 1100a may perform the face tracking operation described with reference to FIGS. 1 to 12. The processor 1100a may generate the facial position information in the interpolated frames.

The optical flow circuit 1300a may include the optical flow circuit 110 described with reference to FIGS. 1 to 12. The optical flow circuit 1300a may operate based on the method described with reference to FIGS. 1 to 12. The optical flow circuit 1300a may detect the optical flow of the image and generate the optical flow map OFMAP. The optical flow circuit 1300a may be configured as separate hardware. The optical flow map OFMAP may be generated by a hardware configuration. The optical flow map OFMAP may be used by the object tracking module 1220a, which is a software module.

The object detection module 1210a may include the face detection module 120 or the object detection module 120a described with reference to FIGS. 1 to 12. The object detection module 1210a may operate based on the method described with reference to FIGS. 1 to 12. The object detection module 1210a may include a software module.

The object tracking module 1220a may include the face tracking module 130 and the object tracking module 130a described with reference to FIGS. 1 to 12. The object tracking module 1220a may operate based on the method described with reference to FIGS. 1 to 12. The object tracking module 1220a may include a software module.

Referring to FIGS. 1 and 13B, an electronic device 1000b may include a processor 1100b and memory 1200b. The memory 1200b may include an object detection module 1210b, an object tracking module 1220b, and an optical flow circuit 1230b. The processor 1100b and the memory 1200b may correspond to the processor 1100a and the memory 1200a described with reference to FIG. 13A. The object detection module 1210b and the object tracking module 1220b may correspond to the object detection module 1210a and the object tracking unit 1220a described with reference to FIG. 13A.

The optical flow circuit 1230b may include the optical flow circuit 110 described with reference to FIGS. 1 to 12. The optical flow circuit 1230b may operate based on the method described with reference to FIGS. 1 to 13b. The optical flow circuit 1230b may detect the optical flow of the video and generate the optical flow map OFMAP. In an embodiment, the optical flow circuit 1230b may include a software module.

As described above, the optical flow circuit 110 in FIG. 1 may include a hardware component and/or a software module included in the electronic device 100. The optical flow circuit 110 in FIG. 1 may generate a sparse optical flow map or a dense optical flow map. The sparse optical flow map may be generated by calculating a movement vector for a specific feature point in the image rather than the entire image. When the optical flow circuit 110 in FIG. 1 generates the sparse optical flow map, the operation time and operation resources may be saved. The dense optical flow map may be generated by calculating a movement vector for the entire feature point in the image. When the optical flow circuit 110 in FIG. 1 generates the dense optical flow map, the facial position information may be generated in more accurate interpolated frames.

The software module may be stored in a non-transitory computer readable medium. In this case, at least one software module may be provided by an OS or may be provided by a given application. Alternatively, some of the at least one software module may be provided by an OS and the others may be provided by a given application.

On the other hand, embodiments described above can be written as a computer-executable program and can be implemented in a general-purpose digital computer that operates the program using a computer-readable recording medium. The computer-readable recording medium includes a storage medium, such as a magnetic storage medium (e.g., read-only memory (ROM), a floppy disk, and a hard disk), an optical reading medium (e.g., a CDROM and a DVD), and a carrier wave (e.g., transmission via the Internet).

The disclosed embodiments may be implemented in a software program comprising instructions stored in the computer-readable storage medium. The computer, which is a device capable of calling stored instructions from a storage medium and performing an operation according to the disclosed embodiments, according to the called instructions, may include the electronic device 100 according to the disclosed embodiments.

The computer-readable storage medium may be provided in the form of a non-transitory storage medium. The term “non-transitory” means that the storage medium does not include a signal and is tangible and does not distinguish whether the data is stored semi-permanently or temporarily in the storage medium.

In addition, the control method according to the disclosed embodiments may be included in a computer program product. The computer program product may be traded between the seller and the buyer as a commodity. The computer program product may include a software program, and a computer-readable storage medium on which the S/W program is stored. For example, the computer program product may include a product (e.g., a downloadable app) in the form of an S/W program that is electronically distributed through the manufacturer of the electronic device 100 or the electronic market (e.g., Google Play Store and App Store). For electronic distribution, at least a portion of the S/W program may be stored in a storage medium or may be temporarily generated. In this case, the storage medium may include a storage medium of a manufacturer's server, a server of an electronic market, or a relay server that temporarily stores the SW program.

The computer program product may include a storage medium of the server or a storage medium of the electronic device 100 in a system including the server and the electronic device 100. Alternatively, when there is a third device (e.g., a smartphone) communicatively connected to the server or the electronic device 100, the computer program product may include a storage medium of the third device. Alternatively, the computer program product may include the S/W program transmitted from the server to the electronic device 100 or the third device or transmitted from the third device to the electronic device 100.

In this case, one of the server, the electronic device 100, and the third device may execute the computer program product to perform the method according to the disclosed embodiments. Alternatively, two or more of the server, the electronic device 100, and the third device may execute the computer program product to implement the method according to the disclosed embodiments in a distributed manner.

For example, the server (e.g., a cloud server and an artificial intelligence server) may execute the computer program product stored in the server to control the electronic device 100 communicatively connected to the server to perform the method according to the disclosed embodiments. As another example, the third device may execute the computer program product to control the electronic device 100 communicatively connected to the third device to perform the method according to the disclosed embodiments. When the third device executes the computer program product, the third device may download the computer program product from the server and execute the downloaded computer program product. Alternatively, the third device may execute the computer program product provided in the preloaded state to perform the method according to the disclosed embodiments.

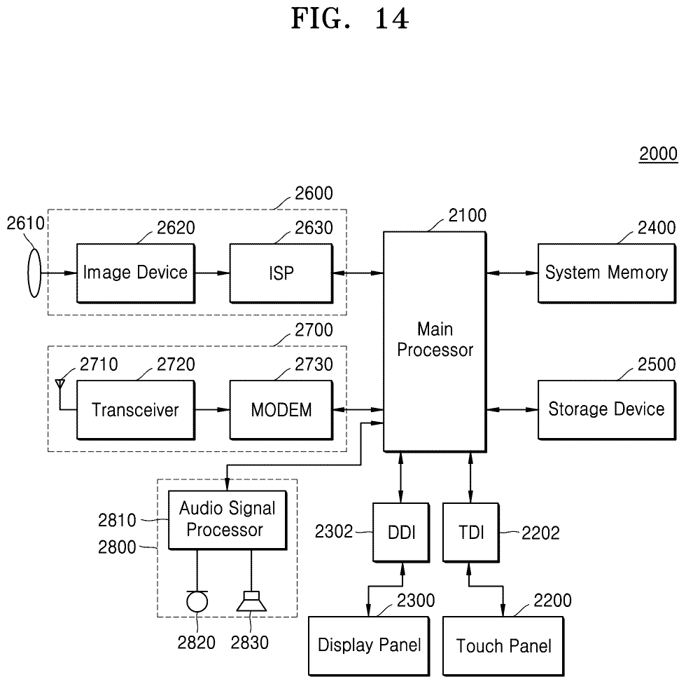

FIG. 14 is a block diagram of an electronic device according to an embodiment.

Referring to FIG. 14, an electronic device 2000 may include a main processor 2100, a touch panel 2200, a touch driving circuit 2202, a display panel 2300, a display driving circuit 2302, system memory 2400, a storage device 2500, an image processor 2600, a communication block 2700, and an audio processor 2800. In an embodiment, the electronic device 2000 may include one of various electronic devices, such as a mobile communication terminal, a PDA, a portable media player (PMP), a digital camera, a smartphone, a tablet computer, a laptop computer, and a wearable device.

The touch driving circuit 2202 may be configured to control the touch panel 2200. The touch panel 2200 may be configured to sense touch input from a user under the control by the touch driving circuit 2202. The display driving circuit 2302 may be configured to control the display panel 2300. The display panel 2300 may be configured to display image information under the control by the display driving circuit 2302.

The system memory 2400 may store data used for operation of the electronic device 2000. As an example, the system memory 2400 may temporarily store data processed or to be processed by the main processor 2100. For example, the system memory 2400 may include volatile memory, such as static random access memory (SRAM), dynamic RAM (DRAM), or synchronous DRAM (SDRAM), and/or non-volatile memory, such as phase-change RAM (PRAM), magneto-resistive RAM (MRAM), resistive RAM (ReRAM), or zero-electric RAM (FRAM). In an embodiment, the output data output from the ISP 2630 may be stored in the system memory 2400.

The storage device 2500 may store data regardless of power supply. As an example, the storage device 2500 may include at least one of a variety of non-volatile memory, such as flash memory, PRAM, MRAM, ReRAM, FRAM, and the like. For example, the storage device 2500 may include embedded memory and/or removable memory of the electronic device 2000.

The image processor 2600 may receive light through a lens 2610. An image device 2620 (or image sensor) and an ISP 2630 included in the image processor 2600 may generate image information about an external object based on the received light. In an embodiment, the ISP 2630 may transmit the image information to the main processor 2100.

The communication block 2700 may exchange signals with external devices/systems via an antenna 2710. A transceiver 2720 and a modulator/demodulator (MODEM) 2730 of the communication block 2700 may process signals exchanged with external devices/systems according to at least one of various wireless communication protocols, such as long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processor 2800 may process an audio signal by using an audio signal processor 2810. The audio processor 2800 may receive an audio input through a mike 2820 or provide an audio output through a speaker 2830.

The main processor 2100 may control the overall operations of the electronic device 2000. The main processor 2100 may control/manage the operations of the components of the electronic device 2000. The main processor 2100 may process various operations to operate the electronic device 2000. The main processor 2100 may execute one or more instructions of the program stored in memory or a plurality of neural network models. The main processor 2100, according to an embodiment, may include a center processing unit (CPU), but is not limited thereto. The main processor 2100 may include an application processor (AP), a graphic processing unit (GPU), and the like.

In an embodiment, the main processor 2100 may operate based on the method described with reference to FIGS. 1 to 12. The main processor 2100 may perform the object detection and object tracking operations described with reference to FIGS. 1 to 12. The main processor 2100 may perform the face tracking operation described with reference to FIGS. 1 to 12. That is, the main processor 2100 may generate facial position information in the interpolated frames. Accordingly, an efficient image processing system may be implemented.

In an embodiment, some of the components of the electronic device 2000 in FIG. 14 may be implemented in the form of a system-on-chip and provided as an AP of the electronic device 2000.

While aspects of the inventive concept have been particularly shown and described with reference to embodiments thereof, it will be understood that various changes in form and details may be made therein without departing from the spirit and scope of the following claims.

What is claimed is:

1. A method of generating facial position information in interpolated frames of an electronic device including a face detection module, an optical flow circuit, and a face tracking module, the method comprising:
receiving, by the face tracking module, a frame and detection data from the face detection module and receiving an optical flow map from the optical flow circuit;
determining, by the face tracking module, at least one patch of the optical flow map based on the frame and the detection data;
calculating an estimated position of a face in the frame based on the patch; and
generating facial position information in interpolated frames based on the calculated estimated position,
wherein the detection data comprises bounding box information of the face included in the frame, and landmark information of the face.

2. The method of claim 1, wherein the determining of the at least one patch comprises at least one of:
determining a first region of the optical flow map corresponding to a center region of a bounding box as a patch;
determining a second region of the optical flow map corresponding to a first landmark region among a plurality of landmark regions of the face as a patch; and
determining a third region of the optical flow map corresponding to the entire region of the bounding box as a patch.

3. The method of claim 1, wherein the determining of the at least one patch comprises:
determining a first region of the optical flow map corresponding to a first landmark region among a plurality of landmark regions of the face;
determining a second region of the optical flow map corresponding to a second landmark region among the plurality of landmark regions of the face; and
determining a combination of both the first region and the second region as the at least one patch.

4. The method of claim 1, further comprising determining a weight for the at least one patch, wherein the calculating of the estimated position of the face in the frame based on the patch comprises calculating the estimated position by applying a weight to the at least one patch.

5. The method of claim 4, wherein the weight is determined based on any one of a constant weight, a Gaussian weight, an L1 norm, and an L2 norm.

6. The method of claim 1, further comprising calculating reliability for the calculated estimated position.

7. The method of claim 6, wherein the reliability is calculated based on any of the following methods: histogram comparison, specific mask, and color comparison of edge regions.

8. The method of claim 1, wherein the optical flow map comprises magnitude information of optical flow and direction information of the optical flow.

9. The method of claim 1, further comprising:
acquiring a video by the optical flow circuit;
detecting, by the optical flow circuit, optical flow indicating movement of an object in the video;
generating, by the optical flow circuit, the optical flow map including magnitude information and direction information of the detected optical flow; and
transmitting, by the optical flow circuit, the optical flow map to the face tracking module.

10. The method of claim 1, further comprising detecting, by the face detection module, the face using a neural network.

11. The method of claim 1, further comprising:
acquiring a video by the face detection module;
performing preprocessing of the video by the face detection module;
detecting, by the face detection module, the face in the frame included in the video using a neural network;
generating detection data by the face detection module; and
transmitting, by the face detection module, the frame and the detection data to the face tracking module.

12. An electronic device comprising:
an optical flow circuit configured to detect optical flow of a received video and generate an optical flow map based on the detected optical flow;
memory configured to store one or more instructions; and
at least one processor configured to execute the one or more instructions stored in the memory, wherein the at least one processor, by executing the one or more instructions, is further configured to:
using a neural network, detect a face in a frame and generate detection data including bounding box information of the face included in the frame and landmark information of the face,
determine at least one patch of the optical flow map based on the frame and the detection data,
calculate an estimated position of the face in the frame based on the patch, and
generate facial position information in interpolated frames based on the calculated estimated position.

13. The electronic device of claim 12, wherein the determining of the at least one patch of the optical flow map comprises at least one of:
determining a first region of the optical flow map corresponding to a center region of a bounding box as a patch,
determining a second region of the optical flow map corresponding to a first landmark region among a plurality of landmark regions of the face as a patch, and
determining a third region of the optical flow map corresponding to the entire region of the bounding box as a patch.

14. The electronic device of claim 12, wherein the at least one processor, by executing the one or more instructions, is further configured to determine a weight for the at least one patch,
wherein the calculating of the estimated position of the face based on the patch comprises calculating the estimated position by applying a weight to the at least one patch.

15. The electronic device of claim 12, wherein the at least one processor, by executing the one or more instructions, is further configured to calculate reliability for the calculated estimated position.

16. The electronic device of claim 12, wherein the optical flow map comprises magnitude information of the optical flow and direction information of the optical flow.

17. A method of generating facial position information in interpolated frames using an optical flow map, the method comprising:
detecting optical flow of a video and generating an optical flow map based on the detected optical flow;
detecting a face in a frame included in the video using a neural network and generating detection data including bounding box information of the face included in the video and landmark information of the face;
determining at least one patch of the optical flow map based on the frame and the detection data;
calculating an estimated position of the face in the frame based on the patch; and
generating facial position information in interpolated frames based on the calculated estimated position.

18. The method of claim 17, wherein the determining of the at least one patch comprises:
determining a first region of the optical flow map corresponding to a first landmark region among a plurality of landmark regions of the face;
determining a second region of the optical flow map corresponding to a second landmark region among the plurality of landmark regions of the face; and
determining a combination of both the first region and the second region as the at least one patch.

19. The method of claim 17, further comprising determining a weight for the at least one patch, wherein the calculating of the estimated position of the face in the frame based on the patch comprises calculating the estimated position by applying a weight to the at least one patch.

20. The method of claim 17, further comprising calculating reliability for the calculated estimated position.
